(19) United States
(12) Patent Application Publication
(10) Pub. No.: US 2010/0127463 A1
(43) Pub. Date: May 27, 2010

(54) SELF-LOCKING KEYLESS DRILL CHUCK

(76) Inventors: Wenhua ZHOU, Taizhou (CN); Qiang Zhao, Taizhou (CN)

Correspondence Address: JACOBSON HOLMAN PLLC, 400 SEVENTH STREET N.W., SUITE 600, WASHINGTON, DC, 20004, US

(21) Appl. No.: 12/622,576

(22) Filed: Nov. 20, 2009

(30) Foreign Application Priority Data
Nov. 24, 2008 (CN) 200820168002.1

(51) Int. Cl. B23B 31/165

(52) U.S. Cl. 279/61

(57) ABSTRACT

This invention provides a self-locking keyless drill chuck comprising a drill body, three clamping jaws, a nut, a front sleeve and a rear sleeve. A thread connection is adopted between the clamping jaws and the nut, wherein the rear sleeve is rotatably installed outside the drill body, the inner side of the front sleeve is provided with a ring gear at the rear part of the nut, a ring which cannot rotate relative to the drill body is arranged outside the drill body, the ring is provided with a member which is with the gear and takes part in self-locking, the rear sleeve is provided with or connected with an inner sleeve rotated with the rear sleeve, the inner sleeve is provided with a structure acting on the member taking part in self-locking. This invention has the advantages of more conveniently assembling and achieving self-locking of the drill chuck through operating the rear sleeve. The drill bit clamped by the clamping jaw cannot be easily loosened and slipped even under the impact of an impulsive load.

### TECHNICAL FIELD

The present invention relates to a drill chuck, in particular to a drill chuck installed on machining facilities and electric tools such as drilling machines and electric drills.

### BACKGROUND TECHNOLOGY

In prior technology, a keyless drill chuck is provided with a drill body, three clamping jaws, a nut, a rotatable front sleeve and a rear sleeve. The front sleeve is axially positioned. Three clamping jaws are respectively arranged in three inclined holes which are evenly arranged on the drill body. A thread connection is adopted between the nut and the clamping jaws. The front sleeve is directly or indirectly connected with the nut. During operation, operating the front sleeve causes the nut to rotate, which in turn drives the clamping jaws to extend out of or retreat into the inclined holes, so that the drill chuck can clamp or loosen the drilling tool. These drill chucks have the disadvantages that, under the impact of an impulsive load, the drill bit clamped by the clamping jaws is easily loosened, slipped or even dropped. Thus, it is difficult to keep continuous operation.

### SUMMARY OF THE INVENTION

An objective of the present invention is to provide a self-locking keyless drill chuck that is not easily loosened and slipped under the impact of an impulsive load. Therefore, the present invention adopts following technical solutions. The present invention comprises a drill body, three clamping jaws, a nut, a front sleeve and a rear sleeve. A thread connection is adopted between the clamping jaws and the nut. The rear sleeve is rotatably installed outside the drill body. The inner side of the front sleeve is provided with a ring gear at the rear part of the nut. A ring that cannot rotate relative to the drill body is arranged outside the drill body. The ring is provided with a member that cooperates with the gear and takes part in self-locking. The rear sleeve is provided with or in connection with an inner sleeve that rotates with the rear sleeve. The inner sleeve is provided with a structure engaging the member taking part in self-locking. Adopting this technical solution, the present invention has the advantages of more convenience in assembling. In addition, self-locking can be achieved through operating the rear sleeve. Accordingly, the drill bit clamped by the clamping jaws of the drill chuck is not easily loosened, slipped or dropped even under the impact of an impulsive load.

### DESCRIPTIONS OF THE DRAWINGS

FIG. 1 is an exterior view of the first and second embodiments of the present invention.

FIG. 2 is a sectional view of FIG. 1 along the line A-A showing main internal structure of the drill chuck.

FIG. 3 is a sectional view of FIG. 1 along the line B-B, where the first embodiment is adopted and the drill chuck is under a non-self-locking status.

FIG. 4 is a sectional view of FIG. 1 along the line B-B, where the second embodiment is adopted and the drill chuck is under a self-locking status.

FIG. 5 is a sectional view of FIG. 1 along the line C-C according to the first embodiment of the present invention.

FIG. 6 is an explosive view of the present invention according to the first embodiment.

FIG. 7 is a perspective view of the ring of the first embodiment of the present invention.

FIG. 8 is a perspective view of the inner sleeve of the first embodiment of the present invention.

FIG. 9 is a sectional view of FIG. 1 along the line A-A, which shows main internal structure of the drill chuck according to the second embodiment of the present invention.

FIG. 10 is a sectional view of FIG. 1 along the line B-B according to the second embodiment of the present invention, where the drill chuck is under a non-self-locking status.

FIG. 11 is a sectional view of FIG. 1 along the line B-B according to the second embodiment of the invention where the drill chuck is under a self-locking status.

FIG. 12 is a sectional view of FIG. 9 along the line E-E.

FIG. 13 is an explosive view of the second embodiment of the present invention.

### DETAILED DESCRIPTION OF THE INVENTION

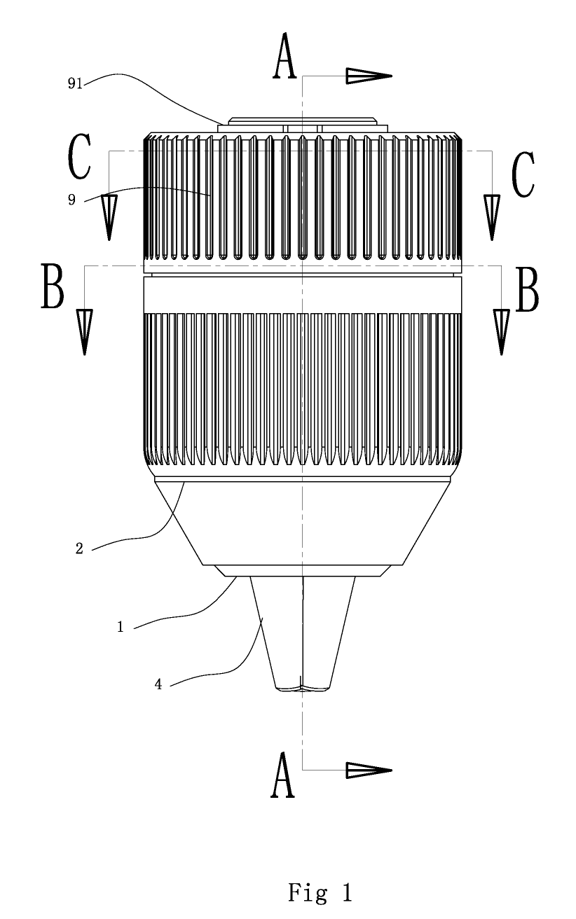

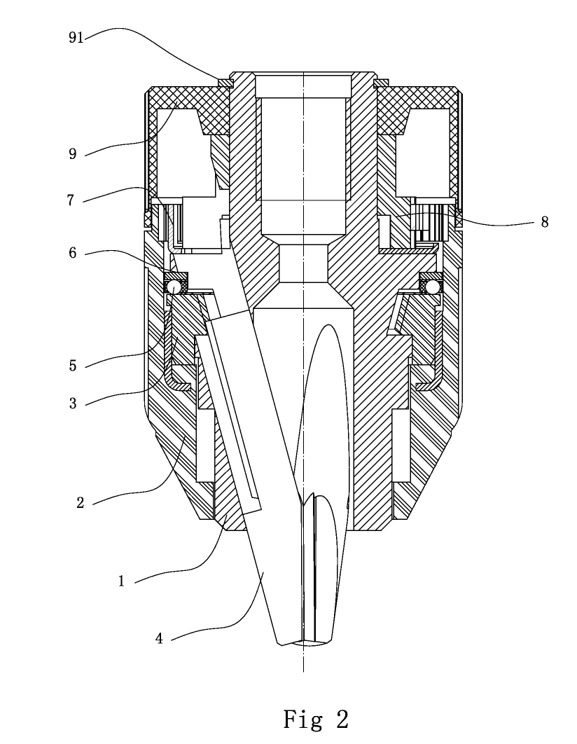

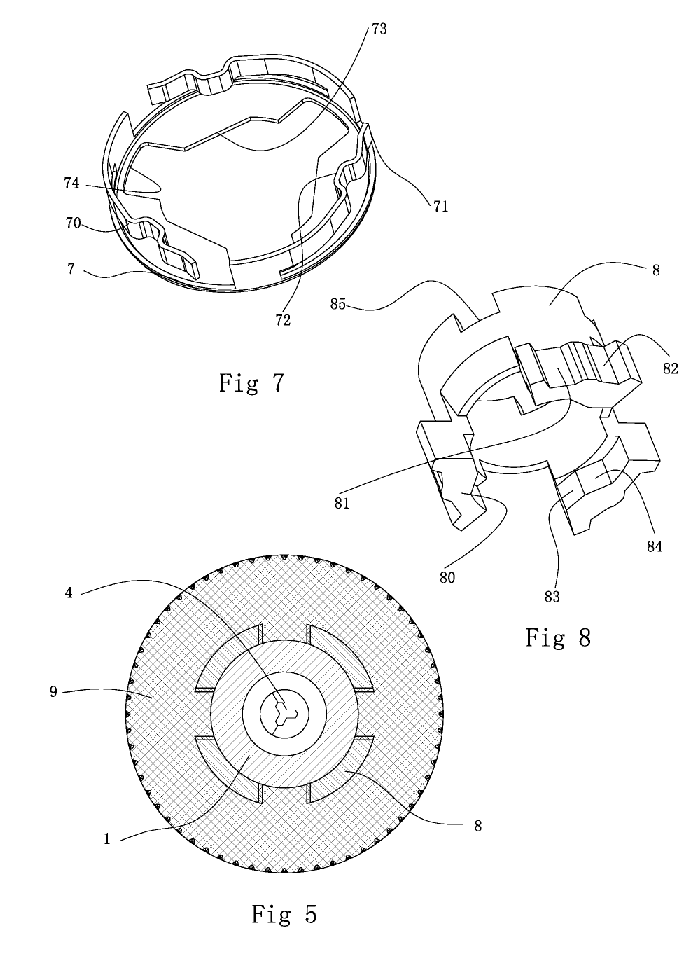

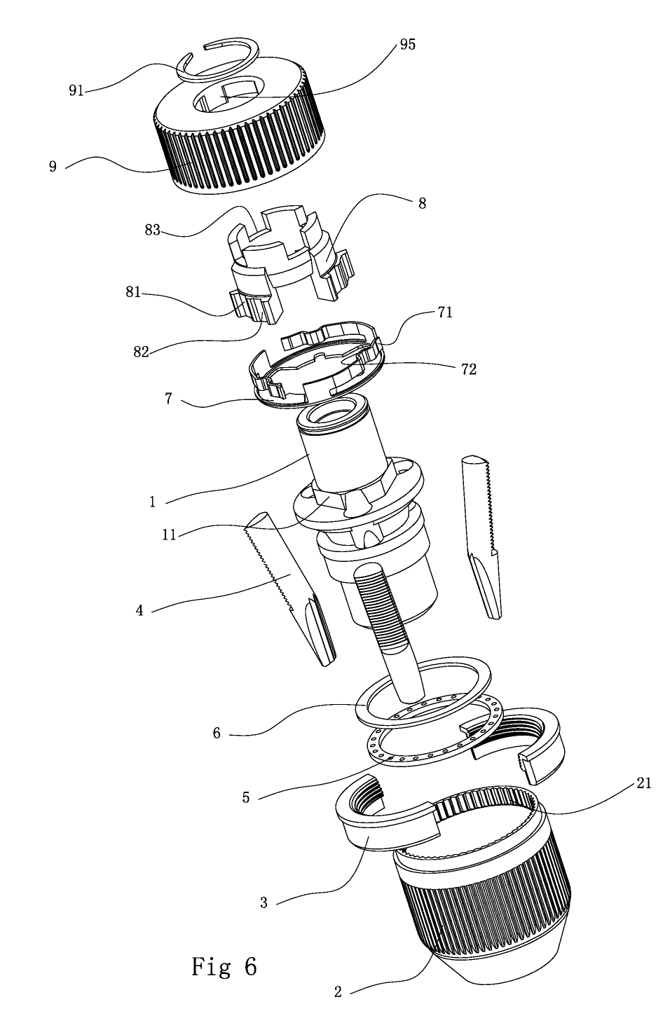

The first embodiment of the present invention is shown in FIGS. 1, 2, 3, 4, 5, 6, 7, and 8.

The present invention comprises a drill body 1, three clamping jaws 4, a nut 3, a front sleeve 2 and a rear sleeve 9. A thread connection is adopted between the clamping jaws and the nut. The rear sleeve is rotatably installed outside the drill body. A collar 91 connects with the drill body. The collar is used for the positioning of the rear sleeve. The inner side of the front sleeve is provided with a ring gear 21 at the rear part of the nut. A ring 7 that cannot rotate relative to the drill body is installed outside the drill body. The ring is provided with a member that cooperates with the gear and takes part in self-locking. The member taking part in self-locking is a spring leaf 70. The rear sleeve 9 is provided with or connected with an inner sleeve 8 that rotates with the rear sleeve. The inner sleeve is provided with a structure 80 acting on the member taking part in self-locking. In this embodiment, for balance, three spring leafs are circumferentially arranged along the ring. Correspondingly, three structures 80 engaging the member taking part in self-locking are circumferentially arranged along the inner sleeve.

The rear sleeve 9 and the inner sleeve 8 can be an integrated structure, an interference-fit structure, a key-slot combination or other connection modes, so that the rear sleeve 9 and the inner sleeve 8 can be connected and rotated together. The embodiment adopts the connection mode of a key-slot combination. Reference numeral 95 is the key in the rear sleeve and number 85 is the slot in the inner sleeve.

The self-locking is a mechanism that prevents the nut from loosening relative to the drill body along the retreating direction of the clamping jaws when the drill chuck is in operation. Using FIG. 1 as an example, the downward direction is the direction that the clamping jaws advance, i.e., the front end direction of the drill chuck. The upward direction is the direction that the clamping jaws retreat, i.e., the rear end direction or the tail part direction of the drill chuck.

The spring leaf 70 comprises a lock end 71 in cooperated with the gear 21 and a protrusion 72 toward the direction of the drill body. The structure 80 which is arranged in the inner sleeve and engages the spring leaf 70 is arranged between the spring leaf and the drill body and is provided with a cam face cooperated with the protrusion 72, so that the lock end 71 of the spring leaf 70 can be inserted into and separated from the gear 21. The cam face comprises a concave surface 82, which correspondingly controls the lock end 71 of the spring leaf 70 inserted into the gear 21, and a concave surface 81, which correspondingly controls the lock end 71 of the spring leaf 70 separated from the gear 21.

The drill body is provided with a positioning structure according to the rotation position of the inner sleeve when the lock end of the spring leaf is being inserted into the gear. The positioning structure is the prismatic protrusion 12 on the surface of the drill body. The inner sleeve 8, or the structure 80 that is arranged on the inner sleeve and acts on the spring leaf, is provided with another positioning structure cooperated with the prismatic protrusion 12. Such another positioning structure is an inner concave 84. This structure assists in providing a stable self-locking mechanism. The drill body is provided with a position-limiting structure that corresponds to the rotation limit of the inner sleeve where the lock end of the spring leaf separates from the gear. The position-limiting structure is the edge plane 11 on the surface of the drill body. The inner sleeve 8, or the structure 80 which is arranged in the inner sleeve and acts on the spring leaf, is provided with a structure in cooperation with the edge plane 11. The structure is the plane 83 in cooperation with the edge plane 11. This arrangement prevents excessive rotation of the rear sleeve and the inner sleeve caused by misoperation as well as structural damages.

The ring 7 can be connected with the drill body in an interference-fit manner to rotate together with the drill body. In this embodiment, the ring 7 is positioned outside of the drill body. The ring 7 and the drill body are provided with a structure preventing their relative rotation. The structure is the edge plane 11 at the ring position and edge 73 inside the ring on the surface of the drill body. Their cooperation prevents relative rotation between the ring 7 and the drill body. Furthermore, the ring 7 is axially limited by the inner sleeve and the drill body. Therefore, the drill chuck has a simpler structure and is more convenient to assemble.

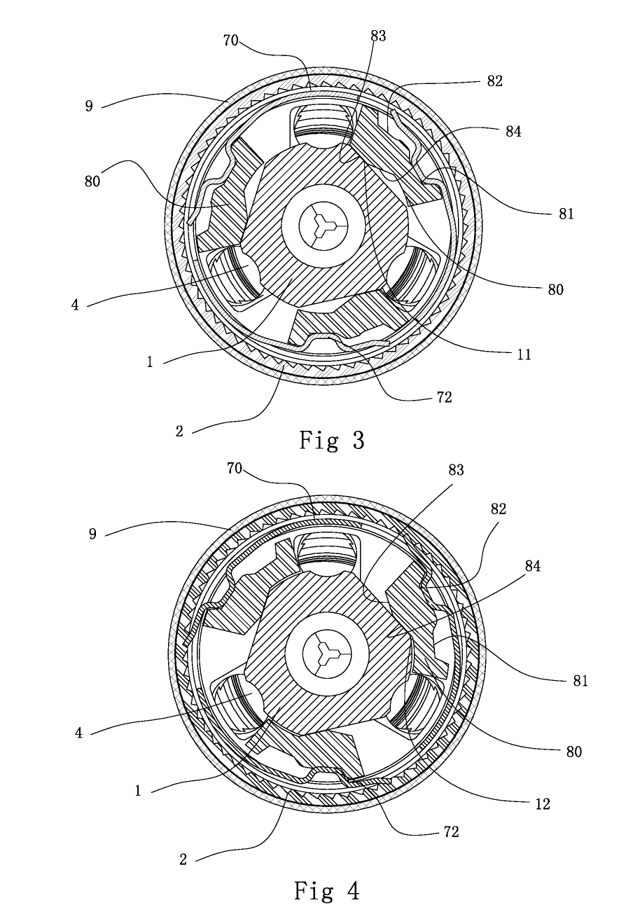

Referring to FIG. 3 and FIG. 4, in this invention, looking from the tail part toward the rear end of the drill chuck, one can see that the section of the cam face cooperated with the protrusion controlling the lock end of the spring leaf to be inserted into the gear is at counterclockwise direction of the section controlling the lock end of the spring leaf to be separated from the gear. This facilitates the operation of the front sleeve and the rear sleeve.

Reference numeral 5 and numeral 6 represent a bearing and a washer between the nut and the drill body, respectively. Reference numeral 74 is a slug hole of the clamping jaws on the ring 7. The front sleeve is connected with the nut. The rotation of the front sleeve can drive the nut to rotate and then make the clamping jaws advance or retreat, thereby clamping or loosening the drill bit.

During operation, as shown in FIG. 3, the lock end 71 is not inserted into the gear 21 and the drill chuck is at non-self-locking status. The plane 83 is propped against the edge plane 11. Then a drill bit or other tools that need to be clamped are placed between the clamping jaws. The front sleeve 2 is rotated counterclockwise direction according to a view looking towards the paper surface. The nut is rotated to make the clamping jaws advance to clamp the drill bit. When the clamping jaws clamp the drill bit, the elastic force of the spring leaf 70 is overcome through continually inputting twisting force. The rear sleeve can rotate clockwise to reach the status of FIG. 4. Then, the protrusion 72 is engaged by the cam face to make the lock end 71 of the spring leaf inserted into the gear 21. The front sleeve is continually rotated to input more twisting force. The gear 21 slips over the lock end 71 until the front sleeve cannot be rotated, thereby inputting twisting force to the utmost extent and increasing the clamping force upon the drill bit. At the status of FIG. 4, because the ring 7 cannot rotate relative to the drill body, and the lock end 71 is inserted into the gear 21, even under the impact of an impulsive load, the nut will not easily counter-rotate relative to the drill body. This prevents the nut from loosening relative to the drill body along the direction that the clamping jaws retreating when the drill chuck is in use. Thus, the drill bit clamped by the clamping jaws cannot be easily loosened and slipped, thereby achieving self-locking.

When clamped tools need to be loosen after use, one can operate the drill chuck according to steps contrary to above steps.

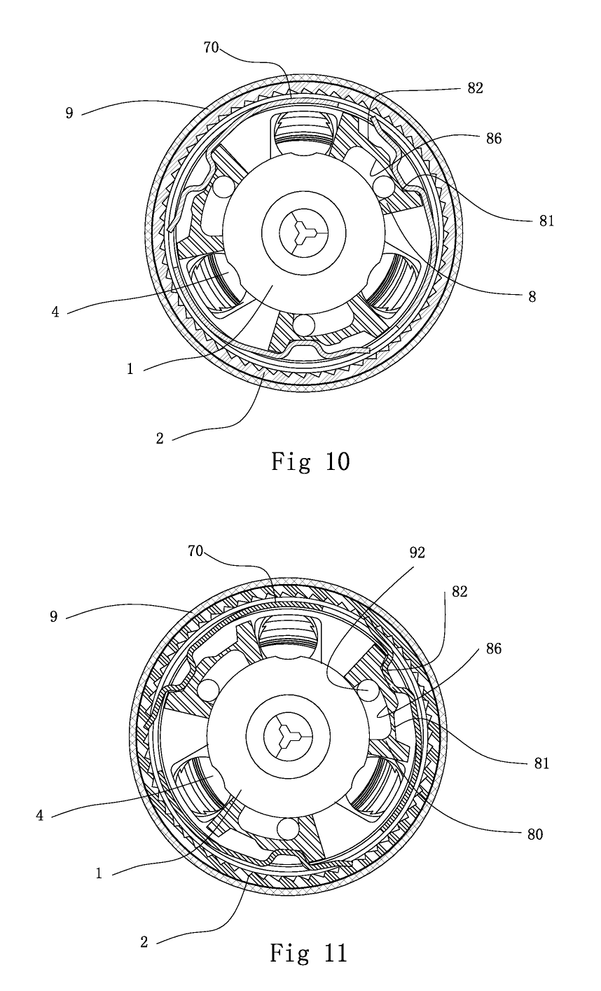

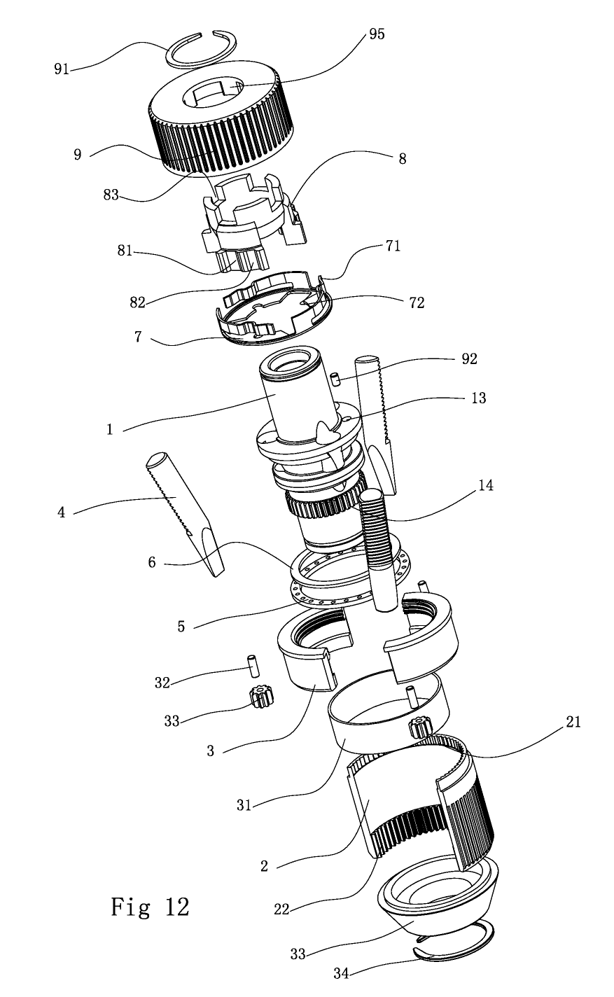

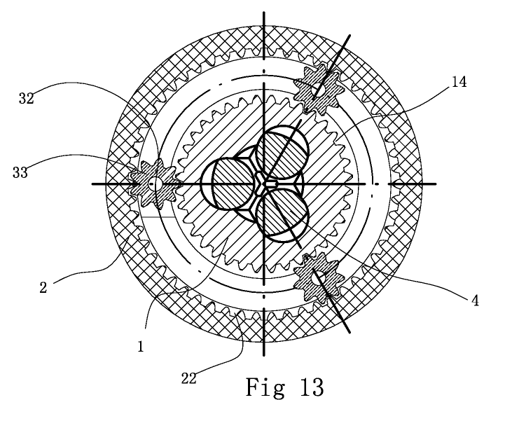

FIGS. 1, 9, 10, 11, 12 and 13 demonstrate the second embodiments of the present invention.

In this embodiment, the inner sleeve 8 or the structure 80 which is arranged in the inner sleeve and engages the spring leaf is provided with a slot 86 to limit the rotation of the inner sleeve. The drill body is provided with a pin 92 in cooperation with the slot. The function achieved by the cooperation between the slot 86 and the pin 92 is the same as the function achieved by the cooperation between the plane 83 and the edge plane 11 and the cooperation between the prismatic protrusion 12 and the inner concave 84 in the first embodiment of the present invention.

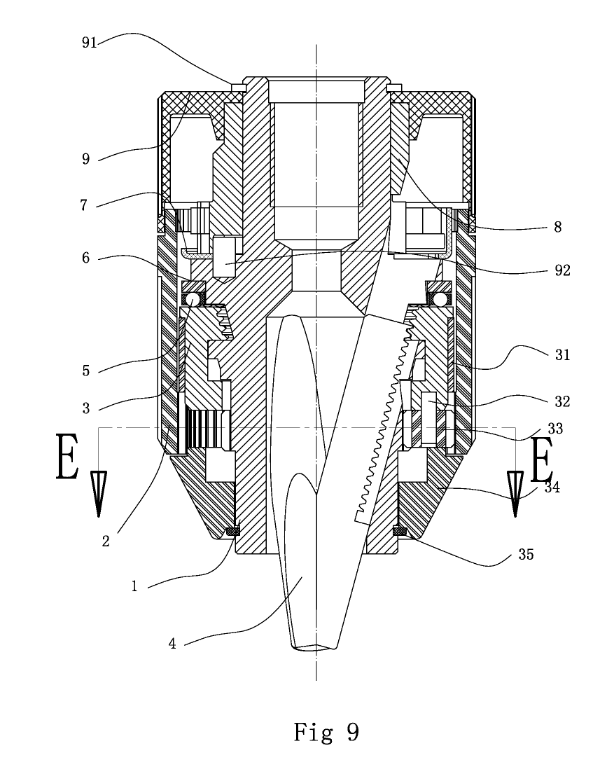

Furthermore, the pin 92 can circumferentially position the ring 7. As shown in FIG. 9, the pin 92 is extended from the step toward the rear end of the drill body. The ring 7 is provided with a circumferential positioning hole used for the insertion of the pin, so that the ring 7 can be positioned circumferentially. The ring 7 is axially limited by the inner sleeve and the drill body. In FIG. 7, reference numeral 13 is an installation hole of the pin 92.

In this embodiment, the front end face of the nut 3 is connected with a plurality of planetary gear 33 which is arranged evenly along the circumferential direction of the nut. The axis of the planetary 32 is arranged on the nut. A center gear 14 meshing with the planetary gear is arranged on the drill body. The center gear 14 can be directly formed on the surface of the drill body or be produced into a ring part before being connected with the drill body. The inner side of the front sleeve is provided with a ring gear 22 meshing with the planetary gear. Reference numeral 31 is the sleeve of the nut, which is connected with two half bodies of the nut to form a complete nut 3.

A front cover 34 is arranged at the front end of the drill chuck, which limits the front sleeve 2 and the planetary gear 33 axially at the front end. The front cover 34 itself is positioned by the collar 35 connected with the drill body.

During operation, when the front sleeve is rotated, the gear 22 drives the planetary gear 33 to move circumferentially on the surface of the center gear 14, thereby driving the nut to move, which in turn causes the claws to clamp tools, and imputing more twisting force. Thus, the drill chuck can have a larger clamping force.

Other parts of the embodiment are the same as the first embodiment. The same reference numerals in FIGS. 9, 10, 11, 12, 13 and FIGS. 1, 2, 3, 4, 5, 6, 7, 8 have the same meaning.

1. A self-locking keyless drill chuck comprising a drill body, three clamping jaws, a nut, a front sleeve and a rear sleeve and thread connection being adopted between the clamping jaw and the nut, wherein the rear sleeve is rotatably installed outside the drill body, an inner side of the front sleeve is provided with a ring gear at a rear part of the nut, a ring which cannot rotate relative to the drill body is arranged outside the drill body, the ring is provided with a member that cooperates with the ring gear and takes part in self-locking, the rear sleeve is provided with or connected with an inner sleeve that rotates together with the rear sleeve, the inner sleeve is provided with a structure engaging the member that takes part in self-locking.

2. The self-locking keyless drill chuck according to claim 1, wherein a front end face of the nut is connected with a plurality of planetary gears which are arranged evenly along circumferential direction of the nut, a center gear meshing with the planetary gears is arranged on the drill body, the inner side of the front sleeve is provided with a second ring gear meshing with the planetary gears.

3. The self-locking keyless drill chuck according to claim 1, wherein the member taking part in self-locking is a spring leaf which comprises a lock end in cooperation with the ring gear and a protrusion toward the direction of the drill body, the structure which is arranged in the inner sleeve and engages the spring leaf is arranged between the spring leaf and the drill body, and is provided with a cam face in cooperation with the protrusion, so that the lock end of the spring leaf can be inserted into and separated from the gear.

4. The self-locking keyless drill chuck according to claim 3, wherein the drill body is provided with a first positioning structure according to rotation position of the inner sleeve where the lock end of the spring leaf being inserted into the gear, the inner sleeve or the structure which is arranged in the inner sleeve and engages the spring leaf is provided with a second positioning structure in cooperation with the first positioning structure; the drill body is provided with a position-limiting structure according to rotation limit for the inner sleeve where the lock end of the spring leaf being separated from the gear, the inner sleeve or the structure which is arranged in the inner sleeve and engages the spring leaf is provided with a structure in cooperation with the position-limiting structure.

5. The self-locking keyless drill chuck according to claim 3, wherein the inner sleeve or the structure which is arranged in the inner sleeve and engages the spring leaf is provided with a slot to limit the rotation of the inner sleeve, the drill body is provided with a pin in cooperation with the slot.

6. The self-locking keyless drill chuck according to claim 5, wherein: the ring is outside the drill body, the pin is extended from a step structure on the drill body toward the rear end of the drill body, the ring is provided with a circumferential positioning hole used for insertion of the pin, the ring is axially limited by the inner sleeve and the drill body.

7. The self-locking keyless drill chuck according to claim 1, wherein the ring is outside the drill body, the ring and the drill body are provided with a structure preventing relative rotation, the ring is axially limited by the inner sleeve and the drill body.

8. The self-locking keyless drill chuck according to claim 3, wherein looking from tail part toward rear end of the drill chuck, the section of the cam face in cooperation with the protrusion controlling the lock end of the spring leaf to be inserted into the gear is at counterclockwise direction of another action of the cam face one controlling the lock end of the spring leaf to be separated from the gear.
